(19) United States
(12) Patent Application Publication
(10) Pub. No.: US 2011/0308642 A1
(43) Pub. Date: Dec. 22, 2011

(54) HYDRAULIC VALVE DEVICE

(75) Inventor: Winfried Rüb, Waldshut-Tiengen (DE)

(73) Assignee: HYDAC FILTERTECHNIK GMBH, Sulzbach/Saar (DE)

(21) Appl. No.: 13/138,527

(22) PCT Filed: Apr. 23, 2010
(86) PCT No.: PCT/EP2010/002501

§ 371 Date: Aug. 31, 2011

(30) Foreign Application Priority Data
May 13, 2009 (DE) 10 2009 021 103.9

(51) Int. Cl. F16K 31/02

(52) U.S. Cl. 137/487.5

(57) ABSTRACT

The invention relates to a hydraulic valve device (1) having a fluid connection arrangement (10) comprising a multiplicity of fluid connection points which can at least partially be actuated by means of a control device (18). As a result of the fact that, by way of a means (2) for measuring the load pressure, the control device (18) can be moved into a rapid traverse position when a maximum load pressure is exceeded in a power stroke position and vice versa, and that at least one fluid-conducting working chamber of a consumer (4) is connected to one of the use connections (A) during a switch of the control device (18) for a change from power stroke to rapid traverse, a jerk-free transition from a working stroke to a rapid traverse is attained and a homogeneous, jerk-free return to the working stroke is enabled when an overload situation is encountered in the rapid traverse.

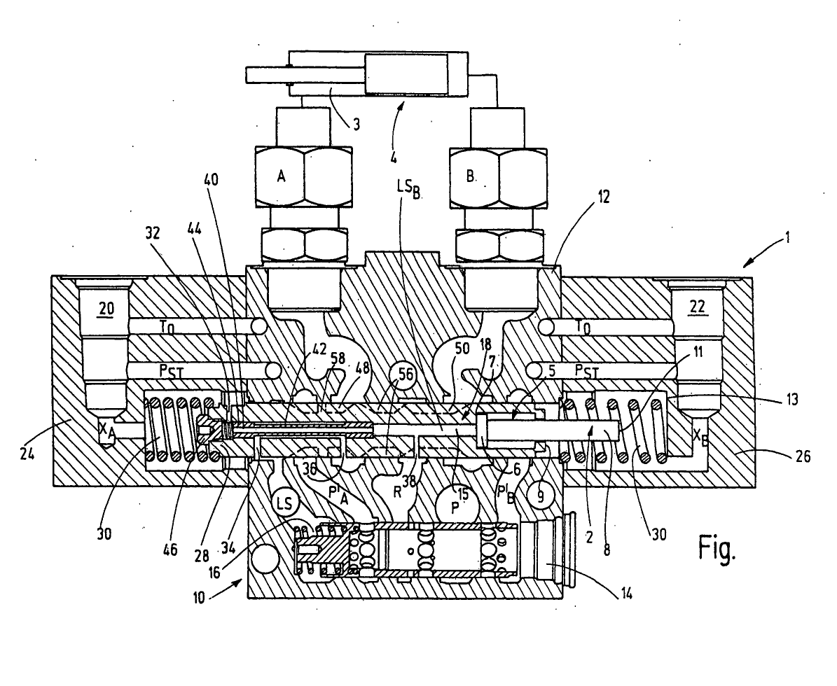

The invention relates to a hydraulic valve device having a fluid connection arrangement comprising at least
one pressure supply connection P,
one return connection R,
one section load sensing connection LS,
two control connections P′_{A} and P′_{B}, and
two user connections A, B
   to which at least one consumer with its fluid-conducting working chambers is connected and with a movable control device for at least partial actuation of connections of the fluid connection arrangement.

DE 10 2005 033 222 A1 discloses an LUDV valve arrangement in which a directional control valve forms an inlet metering orifice to which an individual compensator is connected downstream. An LUDV control is considered a special case of a load sensing control in which the highest load pressure of the hydraulic consumer is reported to a variable displacement pump, and the latter is controlled such that with respect to the pump output there is a pump pressure which is above the load pressure by a certain pressure difference. By way of the LUDV valve arrangement, a hydraulic consumer in the form of a hydraulic working cylinder or consumer cylinder is actuated, which is connected to two consumer connections of the control arrangement. To set a rapid traverse, the two pressure chambers of the consumer can be connected to one another and to a hydraulic fluid source. In order to prevent drop-off of the consumer in operation, this connection of the two consumer connections takes place via a hydraulic fluid flow path in which there is a nonreturn valve. By way of the directional control valve itself, only the connection to one of the consumer connections is opened; the connection of the other consumer connection to the hydraulic fluid source and/or the first mentioned consumer connection is possible in rapid traverse only via the hydraulic fluid flow path and the nonreturn valve. For a hydrostatic consumer, this construction measure means that a hydraulic fluid flow from a piston rod-side annulus to a bottom-side cylinder chamber is fundamentally allowed only as long as the pressure in the latter is less than or about equal to the pressure on the piston rod side.

A solution comparable to DE 10 2005 033 222 A1 is also shown by EP 1 647 719 A2, which relates to a regeneration valve device with an independent, separate regeneration valve which responds when the consumer cylinder is extended to establish a fluid connection from the bottom side to the annular side of the consumer cylinder, the two indicated pressure chambers of the consumer cylinder then being connected to the return connection R in order to avoid or counteract a possible acceleration jolt, so that the cylinder in rapid traverse is not braked or even stopped by high loads. For the use of the indicated regeneration valve, the corresponding installation space must be created in the valve housing. In addition, the known regeneration valve has a complex structure; this may result in increased production costs.

EP 1 184 576 B1 describes a valve device for actuating a consumer, especially in the form of a so-called mowing head for a full mower, which can also be used in forestry operations, where a pressure limitation of the load pressure which prevails on the respective consumer of the mowing head is enabled by a control piston or movable control device of a hydraulic valve arrangement, when a boundary load pressure is exceeded, to be movable into a pressure limitation position. In said pressure limitation position, the consumer connection which carries the load pressure is connected to a tank connection and the load pressure at this consumer connection furthermore acts in the flow direction on the control piston. This type of an individual pressure limitation can prevent damage to the connected consumer by pressure peaks.

DE 603 04 663 T2 in turn describes a hydraulic valve arrangement with a supply connection arrangement which has a high pressure connection P and a low pressure connection T, a working connection arrangement with two working or user connections A, B which can in turn be connected to a hydraulic consumer, a direction valve, and a compensation valve disposed between the direction valve and the supply connection arrangement P, T and whose pressure output is connected to a pressure input of the direction valve. The compensation valve has a relief output which can be connected to a pressure output and has a valve element, which can be moved out of an initial position in opposite directions, in the form of a slide, which is exposed on one side to the pressure in the load sensing line and the force of a spring and on the opposite side to the pressure at the pressure output. When the valve element moves in one direction, it takes on a pressure control function and when moved in the opposite direction a pressure relief function. The control slide has a longitudinal channel which is connected via a transverse bore to the pressure output and ends in a first pressure chamber. The longitudinal channel in turn extends beyond the transverse bore and leads via a closable opening to a second pressure chamber in which a relief pressure prevails. With this known solution, it is possible to be able to counteract so-called parasitic pressure propagations, and in solutions of this type, unwanted lifting of loads can occur, subject to leaks.

Proceeding from the indicated prior art, the object of the invention is to devise, in an economical manner which saves installation space, a reliable hydraulic valve arrangement which avoids an acceleration jolt when the power stroke is switched over to a rapid traverse and which enables monitoring of the load pressure.

This object is achieved by a hydraulic valve device with the features of claim 1 in its entirety.

In that, according to the characterizing part of claim 1, the position of the control device can be adjusted by a means for measuring the load pressure simultaneously with the measurement, it is enabled that in a rapid traverse position of the control device, the control device is returned to a power stroke position when a maximum pressure is exceeded. This takes place jerk free since it is provided according to the invention that a valve opening cross section between a feed line and a working connection is not changed in the transition from power stroke to rapid traverse position. It is furthermore provided that during switchover the backflow from an assignable working chamber of the hydraulic consumer is connected to a feed channel in the form of one of the user connections. If in turn the load pressure drops during the power stroke, the force on the means for measuring the load pressure also drops, and the movable control device assumes a proportional intermediate position between the power stroke and the rapid traverse.

In an especially advantageous embodiment of the valve arrangement, it is provided that the means for measuring the load pressure is a measuring cylinder with a measurement piston whose first working chamber is connected to the section load sensing connection to conduct fluid and in the rapid traverse and in the power stroke is pressurized and its piston rod projects into an actuation space of the control housing of the movable control device.

Preferably, the measurement piston is arranged to be able to move axially to the control slide, and a longitudinal channel in the control slide connects the load sensing connection to the first working chamber of the measuring cylinder. The measuring cylinder is an integral component of the control slide which, in an especially preferred exemplary embodiment, can be moved beyond a maximum working position into the rapid traverse position.

In the rapid traverse position, one control connection of the control slide is connected to one of the user connections, especially in the form of a working chamber of the hydraulic consumer, to conduct fluid. Furthermore, pocket-like connecting channels extend in the control device between a load reporting connection and a further user connection for the consumer.

Preferably, the movable control device is provided with further load reporting and load sensing connections which, connected in pairs to one another, assign one load reporting connection to one load sensing connection and which, depending on the travel position of the control device, connect at least part of the connections of the fluid connection arrangement to one another to conduct fluid.

In one especially preferred embodiment of the hydraulic valve device, the consumer comprises a consumer cylinder or working cylinder with an annulus and a piston chamber as fluid-conducting working chambers. It is furthermore provided that when changing from power stroke to rapid traverse, the annulus of the consumer cylinder is connected to the user connection A as a feed line. In addition to a use for working cylinders or consumer cylinders, the hydraulic valve device can, however, also be used in other hydraulic drives, such as, for example, traction drives of electro-hydraulic vehicles and more. This paired hydraulic motor arrangement then has fluid-conducting working chambers, and a working chamber of the respective hydraulic motor, which corresponds to the annulus of the working cylinder, is then to be connected to the feed line via the user connection A to the former; and the other fluid-conducting chambers of the respective hydraulic motor are to be actuated as a working chamber comparable to the piston chamber of the indicated consumer cylinder.

The hydraulic valve device according to the invention is detailed below using one exemplary embodiment as shown in the drawings. Here the single FIGURE shows a partial longitudinal section through the valve device according to the invention schematically and not to scale.

The FIGURE shows in a partial longitudinal section a valve arrangement 1 with a fluid connection arrangement which is designated as a whole as 10 and which among other things comprises a pressure supply connection P, a return connection R, a section load sensing connection LS, two control connections P′_{A} and P′_{B}, and two user connections A, B.

The fluid connections LS, P′_{A}, R, P and P′_{B}, A and B are accommodated in a common control housing 12, the end of the control housing 12, which is the lower one seen in the FIGURE, being provided with a conventional compensator 14 which is connected upstream of the connections LS, P′_{A}, R, P, and P′_{B} and actuates them. The compensator 14 enables especially a so-called cutoff of the amount of hydraulic fluid by a pressure limitation (LS), which is not shown, in a spring chamber 16 of the compensator 14 in order, for example, for a fluidic consumer which is connected to the user connections A, B and which is located on a stop, generally in the form of a hydraulic consumer cylinder 4, to cut off the inlet amount to avoid overloads on the consumer.

A movable control device 18 of the valve arrangement 1 is actuated by two pilot valves 20, 22 which for the sake of simplicity are shown only in the FIGURE as their respectively assignable housing connections in the control housing 12. This actuation via pilot valves is conventional, so that it is not detailed here. Otherwise, the respective pilot valve 20, 22 is accommodated in an assignable housing 24, 26. Said housings are flanged on both sides on the middle part of the control housing 12 and, in addition to the conventional connections T₀ and P_{ST}, also have connections on the bottom for purposes of applying two control pressures X_{A} and X_{B} which act in opposite directions. By way of the connection P_{ST}, the pump control pressure prevails at the respective pilot valve 20, 22, and furthermore these pilot valves are connected to the indicated tank connection line T₀.

The indicated control device 18 has a control slide 28, which can be moved horizontally viewed in the direction of looking at the FIGURE and which is shown in the FIGURE in its floating position which is deflected to the left. The neutral position is effected by two spring storages which act in opposite directions in the form of compression springs 30 which are integrated in a spring chamber through which hydraulic fluid X_{A}, X_{B} flows in the pilot housings 24, 26.

The control device 18 with the control slide 28 is provided with load reporting connections 32, 34 and with load sensing connections 36, 38 which are connected in pairs to one another to conduct fluid. The first load reporting connection 32 is connected to the second load sensing connection 38 to conduct fluid, and the second load reporting connection 34 is connected to the first load sensing connection 36 to conduct fluid. These connections are made as radial transverse bores in the control slide 18 and, depending on the travel position of the control slide 28, enter into respectively opening or blocking connection to the assignable connections of the fluid connection arrangement 10 according to the FIGURE.

The control slide 28 along its outer periphery has at least two pocket-like control channels 48, 50 which are oriented longitudinally and which in the neutral position of the control slide 28 discharge into the user connection A and user connection B, respectively. Furthermore, in the control channel 48, at least in the region of the user connection A, a subdividing partition 58 is incorporated. In the floating position of the control slide 28 shown in the FIGURE, the user connection A is connected to conduct fluid to fluid-conducting pockets 56 which are made in the outer periphery of the control slide 28 and which discharge in the illustrated position into an annular channel which surrounds the control slide 28 and which is connected in turn to the return connection R. The control channel designated as 50 with its opening cross section in the direction of the user connection B forms the so-called metering orifice of the valve device, and, viewed in the direction of looking at the FIGURE to the left of the partition 58, the other part of the pocket-like control channel 48 is responsible for the backflow into the feed channel P′_{A} in the rapid traverse.

Connecting channels 40, 42 which are located within the control slide 28 are used to produce the fluid-conducting connection between the load reporting and load sensing connections 32, 36; 34, 38 which can be assigned to one another in pairs. Here a connecting channel 40 is made as a so-called middle channel which, in the neutral position of the control device 18 shown in the FIGURE, with its axial length overlaps the region between the section load sensing connection LS and the user connection B. This middle channel 40, viewed in the direction of looking at the FIGURE, begins on the left side of the control slide 28 and runs along its middle axis into the bore of the measuring cylinder 5. The connecting channel 42 is provided parallel as a longitudinal annular channel which, in the neutral position of the control device 18, with its axial overall length covers at least the region between control connection P′_{A} and user connection A.

The middle channel 40, to border the possible channel guides, is bordered in this respect on the edge side by an insert sleeve 44 which, arranged at least partially lengthwise along its outer periphery in a definable middle region, borders the longitudinal annular channel 42 with the inside wall of the control slide 28 in this region. The longitudinal annular channel 42 can also be formed from a plurality of individual channels arranged concentrically to the middle channel 40 (not detailed). The axial length of the insert sleeve 44 extends, according to the FIGURE, between the first load reporting connection 32 and a narrowed offset site between the first load sensing connection 36 and second load sensing connection 38 at the height of the return connection R. While the insert sleeve 44 with its one end, which is the right end viewed in the direction of looking at the FIGURE, is supported on the indicated narrow site within the longitudinal bore of the control slide 28, the opposite other free end in the region of the first load reporting connection 32 is rested on a compression spring which extends between a terminating plug 46 and the free sleeve end and in this way keeps the insert sleeve 44 in its position with a definable prestress. Length tolerances which may be present in the system insert sleeve 44 to the inside of the control slide 28 can be equalized via this arrangement.

A rapid traverse position for the connected hydraulic consumer 4 is attained by the control slide 28 being moved beyond the so-called lifting position to the right as viewed in the direction of looking at the FIGURE, and the so-called floating position for the consumer can be reached to the left by a type of overstroke of the control slide 28 by way of the so-called lowering position, viewed in the direction of looking at the FIGURE. Proceeding from the neutral position shown in the FIGURE, therefore the control slide 28 is moved to the right first into the lifting and then into the rapid traverse position for the consumer or in the opposite direction proceeding from the neutral position to the left by way of the lowering position into the floating position; otherwise, the control channel 50 with increasing traveling motion of the control slide 28 in the direction of the lifting position intersects the control connection P′_{B}, which leads to an increase of the relevant cross section of the metering orifice.

Viewed in the direction of looking at the FIGURE, in the right region of the control slide 28, there is a means 2 made as a measuring cylinder 5 for measuring the load pressure in the user connection B. The measuring cylinder 5 has a measurement piston 6 and a piston rod 8 which is reduced in diameter relative to the measurement piston 6. Furthermore, the piston rod 8 on its right free end projects through a bottom 9 of the control slide 28, and the free right end of the piston rod 8 discharges into the spring chamber which is connected to the pilot control connection X_{B}. The load sensing connection 38, which discharges into the return connection R in the illustrated middle or neutral position of the control slide 28, is transferred on the opposite connection side into a longitudinal channel 15 which is connected to the middle channel 40 to conduct fluid. On its right side which faces away from the middle channel 40, the longitudinal channel 15 discharges into a first working chamber 7 of the measuring cylinder 5, which in the illustrated representation is filled by the measurement piston 6 which in addition also closes the right free channel end cross section of the longitudinal channel 15.

If the control slide 28 moves to the right, viewed in the direction of looking at the FIGURE, the control slide likewise entrains the measuring cylinder 5 to the right with the result that the load sensing connection 38 overlaps the annular channel to which the user connection B is connected so that in this right position the load sensing connection 38 is used as a load sensing connection LS_{B} for the load pressure prevailing in the user connection B, this load sensing pressure LS_{B} being relayed in turn to the measuring cylinder 5 by way of the longitudinal channel 15. Accordingly, the load sensing connection 38 is continued by way of the longitudinal channel 15 as a section load sensing connection LS_{B} and discharges into the first working chamber 7 of said measuring cylinder 5.

If the load pressure in the user connection B rises to very high values, the measuring cylinder 5 is moved to the right at least until the piston rod 8 with its right free end 11 strikes the termination wall 13 of the spring chamber of the pilot housing 26. This results in a counterforce on the control slide 28 in the direction of a transition from a rapid traverse position into the lifting position. In this way, for an excess load on the piston rod unit of the consumer cylinder 4, a jerk-free transition into a load application to a load-bearing hoist which is dynamically connected to the consumer cylinder 4 and a position which produces a maximum lifting force for the control slide 28 can be achieved. If, conversely, the load pressure in the power stroke in turn drops, the compressive force which is acting on the measurement piston 6 via the load sensing connection LS_{B} also drops, and the control slide 28 assumes a proportional intermediate position between power stroke and rapid traverse, where a throttled connection of the annulus 3 of the consumer cylinder 4 to the return connection R is formed. To prevent a situation in which no hydraulic fluid continues to flow into the annulus 3 from the user connection A, there should preferably be a throttle or nonreturn valve arrangement, which is not detailed.

Therefore, according to the invention, the free cross section of the valve opening 50 is not changed between feed line P and working connection B in the transition from the power stroke to rapid traverse. During switchover, only the backflow from the annular side 3 of the consumer 4 is no longer switched to T, but connected to the feed channel in the form of the user connection A. To keep the lifting speed constant, monitoring of the load pressure with the indicated measurement means 2 and a load-dependent switchover from rapid traverse to power stroke are undertaken. If the cylinder piston unit of the consumer 4 is moved in the rapid traverse and in so doing the load pressure rises to the allowed maximum pressure, then the measuring cylinder arrangement 5 in the control slide 28 switches the latter back into the power stroke. Then the maximum lifting force is again available, and as a result of the connection of the backflow from the annular side 3 into the feed channel, there is no inadvertent jerking when switching.

If the load pressure in the power stroke now drops, the force on the measuring cylinder 5 also drops, and the control slide 28 assumes a proportional intermediate position between power stroke and rapid traverse, where a throttled connection of the cylinder annular side 3 to the T-return is formed. The throttled pressure on the cylinder annular side 3 must be set lower than the feed pressure in the pump inlet P, because only in this way can the lifting force be increased. Now, for this reason the volumetric flow can no longer flow back into the feed channel out of the cylinder annular side 3 (no regeneration). So that conversely a volumetric stream does not flow out of the feed channel A to the annular side 3 of the consumer, either the throttle side must separate the pressure chambers from one another or a nonreturn valve as shown must prevent throughflow. Another hydraulic consumer can also replace the consumer cylinder or working cylinder 4, for example, in the form of a hydraulic motor for a traction drive, whether in a vehicle or in a lifting means, such as an elevator and the like. In this case, a fluid-conducting working chamber of the consumer in correspondence to the annulus 3 of the consumer cylinder 4 in a switchover of the control device 18 for purposes of changing from the power stroke to rapid traverse can then be connected to the user connection A or B as an active feed line.

1. A hydraulic valve device having a fluid connection arrangement (10) comprising at least
one pressure supply connection (P),
one return connection (R),
one section load sensing connection (LS),
two control connections (P′_{A}) and (P′_{B), and}
two user connections (A, B)
to which at least one consumer (4) with its fluid-conducting working chambers is connected, and with a movable control device (18) for at least partial actuation of connections of the fluid connection arrangement (10), characterized in that the control device (18) can be moved by a means (2) for measuring the load pressure into a rapid traverse position when a maximum load pressure is exceeded into a power stroke position and vice versa and that in a switchover of the control device (18) for purposes of a change from power stroke to rapid traverse at least one of the working chambers of the consumer (4) is connected to one of the user connections (A).

2. The hydraulic valve device according to claim 1, characterized in that the means (2) for measuring the load pressure is a measuring cylinder (5) which has a measurement piston (6), where the first working chamber (7) of said cylinder is connected to the section load sensing connection (LS_{B}) to conduct fluid and is pressurized in the rapid traverse and power stroke.

3. The hydraulic valve device according to claim 2, characterized in that the measurement piston (6) is provided with a piston rod (8) which in each traveling state of the measurement piston (6) with its free end projects into an actuation space (X_{B}) of a pilot housing (26) to which a pilot valve (22) is connected.

4. The hydraulic valve device according to claim 2, characterized in that the measurement piston (6) is arranged to be able to move axially in the control slide (28) and a longitudinal channel (15) in the control slide (28) connects the load sensing connection (LS_{B}) to the first working chamber (7) of the measuring cylinder (5) to conduct fluid.

5. The hydraulic valve device according to claim 2, characterized in that the measuring cylinder (5) is located within the movable control device (18).

6. The hydraulic valve device according to claim 1, characterized in that the movable control device (18) can be moved beyond a maximum working position for the consumer (4) into a rapid traverse position in the direction of one pilot valve (22).

7. The hydraulic valve device according to claim 1, characterized in that the control device (18) is provided with load reporting and load sensing connections (32, 34; 36, 38) which, connected in pairs to one another, assign one load reporting connection to one load sensing connection (32, 38; 34, 36) and which, depending on the travel position of the control device (18), connect at least part of the connections of the fluid connection arrangement (10) to one another to conduct fluid.

8. The hydraulic valve device according to claim 7, characterized in that
the load sensing connection (38) forms a radial transverse bore in the control device (18) which discharges into the longitudinal channel (15) of the control device (18) and which taps the pressure on the load sensing connection (LS_{B}) as soon as the load sensing connection (36) discharges into the user connection (B) to which the assignable working chamber of the consumer (4) is connected.

9. The hydraulic valve device according to claim 1, characterized in that the consumer (4) is formed from a consumer cylinder with an annulus (3) and a piston chamber as fluid-conducting working chambers and that when changing from power stroke to rapid traverse, the annulus (3) is connected to the user connection (A) as a feed line.

10. The hydraulic valve device according to claim 1, characterized in that the cross section of the valve opening cannot be changed between a feed line and a working connection in the transition from power stroke to rapid traverse position.
